(19) United States
(12) Patent Application Publication
(10) Pub. No.: US 2014/0042237 A1
(43) Pub. Date: Feb. 13, 2014

(54) Method for Use of Nozzle for Creating Geyser-Like Fountains By Combining Carbonated Soda and Small Objects

(71) Applicant: EepyBird, LLC, Buckfield, ME (US)

(72) Inventors: Stephen Mark Voltz, Norfolk, MA (US); Frederick Grobe, Buckfield, ME (US)

(73) Assignee: EepyBird, LLC, Buckfield, ME (US)

(21) Appl. No.: 14/054,017

(22) Filed: Oct. 15, 2013

Related U.S. Application Data
(62) Division of application No. 11/859,542, filed on Sep. 21, 2007, now abandoned.
(60) Provisional application No. 60/847,196, filed on Sep. 26, 2006.

(51) Int. Cl. B05B 1/02

(52) U.S. Cl. CPC B05B 1/02
USPC 239/1

(57) ABSTRACT

The present invention includes a nozzle for creating and controlling geysers erupting from carbonated soda bottles. The present invention also includes methods of starting and controlling soda geyser fountains including remote triggering and chain reaction geysers. The nozzle of the invention is used for combining ordinary carbonated soda and small objects. The small objects are typically candies, such as MENTOS. The combination of soda and small objects creates a reaction that rapidly releases carbon dioxide causing tall, geyser-like fountains of soda. The nozzle includes a base section for securing to a bottle of soda, a pin and chamber section for holding small objects, and a nozzle orifice for controlling fluid flow.

### CROSS-REFERENCE TO RELATED APPLICATIONS

This utility patent application claims priority from U.S. patent application Ser. No. 11/859,542 filed Sep. 21, 2007, and titled “Nozzle for Creating Geyser-Like Fountains By Combining Carbonated Soda and Small Objects” in the names of Stephen Mark Voltz and Frederick Grobe, which claims priority from U.S. provisional patent application Ser. No. 60/847,196 filed Sep. 26, 2006, and titled “Nozzle for Creating Geyser-Like Fountains By Combining Carbonated Soda and Small Objects” in the names of Stephen Mark Voltz and Frederick Grobe.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2013 EepyBird.

### BACKGROUND OF THE INVENTION

1. Field of the Invention

The present invention relates to toys and devices for creating eruptions.

2. Background

A popular stunt currently seen on many internet videos involves dropping candies into bottles of carbonated soda to create a soda geyser. Dropping candies into soda causes the soda to erupt rapidly and shoot out of the bottle as much as ten to fifteen feet into the air.

3. Description of Prior Art

Referring to FIG. 1, there is a known method for increasing the height and duration of these soda geysers. The method involves making small holes in four to seven candies 20, and making hole 22, approximately ¼ inch in diameter, in soda bottle cap 24. Candies 20 are threaded on string or wire 26 as if the candies were beads. The end of string 26 of candies is threaded through ¼ inch hole 22 in bottle cap 24 so that candies 20 hang below bottle cap 24. Bottle cap 24 having threaded candies hanging below is replaced on a full bottle of soda so that candies 20 hang just above the level of the soda 28 in the bottle.

By grasping thread 26 with a binder clip or clothespin, the loaded soda bottle may remain in place and the geyser can be triggered by removing the clip or clothespin allowing the threaded candies to fall into the soda. When the candies fall into the soda the candies cause the carbonation in the soda to be released rapidly, and the resulting geyser erupts higher, and lasts longer than a geyser created by simply dropping candies into an open bottle of soda. The duration of a fountain is longer, and fountain is higher, because the soda exits through the smaller opening, created by the ¼ inch hole, instead of the larger open mouth of the bottle.

The candy hanging method is inherently unstable, however, because the candies hang a very short distance above the top surface of the soda. A slight disturbance of a bottle loaded with candies can prematurely start the reaction that causes the geyser. In addition, this method requires drilling of both candies and bottle caps, threading of candies onto string or wire, and threading those strings or wires through the bottle cap—all of which is time consuming.

U.S. Pat. No. 5,692,945 issued to Crowell (Dec. 2, 1997) and titled “Toy Producing Simulated Eruption” discloses a toy for mixing reagents. The toy includes a bottle having two chambers, each for holding reagents, and a connector tube between the two chambers. As one chamber is squeezed, the reagents mix and create an eruption that is ejected from a nozzle orifice. The toy of Crowell is essentially designed to mix baking soda and vinegar for eruptions used with model volcanoes.

International Patent Application Publication WO 02/13937 by Broshi (Feb. 21, 2002) and titled “Exploding Toy Capsule” describes an exploding toy device. The toy capsule contains a chamber with candy and Sodium Carbonate. When mixed with water, the capsule generates carbon dioxide which generates pressure and explodes the capsule scattering candy. Water is injected into the chamber by squeezing a small container attached to the capsule.

What is needed, therefore, is a device for creating a soda geyser that (1) eliminates the need for drilling candies or drilling bottle caps, (2) is more stable and less prone to accidental premature triggering than the method currently in use, and (3) allows geysers to erupt in a number of different esthetically pleasing fountain effects. What is needed, therefore, is a device that overcomes the above-mentioned limitations and that includes the features enumerated above.

### BRIEF SUMMARY OF THE INVENTION

The present invention includes a nozzle for creating and controlling geysers from carbonated soda bottles. The present invention also includes methods of starting and controlling soda geyser fountains. The invention is used for combining ordinary carbonated soda and small objects. The small objects are typically candies, such as MENTOS. The combination of soda and small objects creates tall, geyser-like fountains that can reach 15 to 25 feet. Other items, even pennies, can be used with the device and to trigger such an eruption. The present invention is designed to accommodate various items or small objects that can trigger a reaction with carbonated soda. Candies, however, work very well with the soda reaction and are preferably used.

In one embodiment, the invention is a nozzle that includes a couple of sections. A base section is threaded or otherwise capable of being secured to an opening of a conventional soda bottle. A chamber section is sized to receive at least one object, which object is of a size to readily fit through an opening of a conventional soda bottle. A pin opening is sized to receive a pin. The pin opening is positioned near the base section so that there is sufficient space in the chamber section to contain one or more objects. A nozzle opening for controlling fluid flow is connected to, or integral with, the chamber section. A pin can be inserted in the pin opening for holding one or more objects. An eyelet, or similar equivalent structure on the pin, can be used to fasten a string for remote release of the pin.

The chamber section is sized sufficiently long to hold one or more objects, such as candies. The nozzle opening can be positioned in various locations on the nozzle. The nozzle can also be constructed with multiple openings in various positions.

In another embodiment, the invention is a nozzle that includes a tube with two ends. The first end of the tube is adapted for being secured to the opening of a conventional soda bottle. The second end of the tube has a nozzle orifice for controlling fluid flow. The tube has a pin opening located near the first end. A removable pin is used for inserting in the pin opening. An inserted pin is capable of holding at least one small object in the tube, such that removing an inserted pin enables at least one small object to pass through the first end of the tube and fall into a bottle of soda. The first end of the tube can be threaded or otherwise adapted for securing to a conventional 2-liter bottle of soda. The tube can be sized large enough to receive one or more MENTOS candies. The second end of the tube can have multiple orifices. The pin can receive a string for remote removal. The nozzle can also be designed with a string guide for linking a first nozzle to a second nozzle for chain reaction geysers.

In another embodiment, the invention is a method of creating a soda geyser. This method includes providing a tubular nozzle as described above. Candies or small objects are loaded into the tubular nozzle. A removable pin is inserted into the tubular nozzle to hold the candies in the tubular nozzle. This creates a loaded nozzle. The loaded nozzle is secured to an opened bottle of soda. The pin is removed which causes candies to fall into a bottle of soda and create an eruption of soda. This method can include using a nozzle with an off-center orifice to create a two-stage geyser effect. The first stage is with the soda bottle upright and shooting an angled fountain. The second stage is with the soda bottle tipped and shooting an approximately vertical fountain. This two-stage effect is caused by the combination of the angled nozzle and the loss of soda serving as ballast as the soda erupts out of the bottle. A string can be attached to the removable pin for remote release. The method can include chain reaction assemblies where either the force from a first geyser or the force from a tipping two-stage bottle is used to trigger a second or subsequent geyser.

### Features and Advantages

A feature of the invention is that the invention eliminates the need for drilling candies or drilling bottle caps. The nozzle provides a quick-loading solution that holds objects with a pin or gate instead of a string. By holding candies above a soda bottle opening and using a remote release pin, the invention is more stable and less prone to accidental premature triggering than the method currently in use. The various designs of orifices and chain reaction methods allow geysers to erupt in a number of different esthetically pleasing fountain effects.

### BRIEF DESCRIPTION OF THE DRAWINGS

In the drawings, closely related figures and items have the same number but different alphabetic suffixes.

FIG. 1 is an illustration of a prior art device.

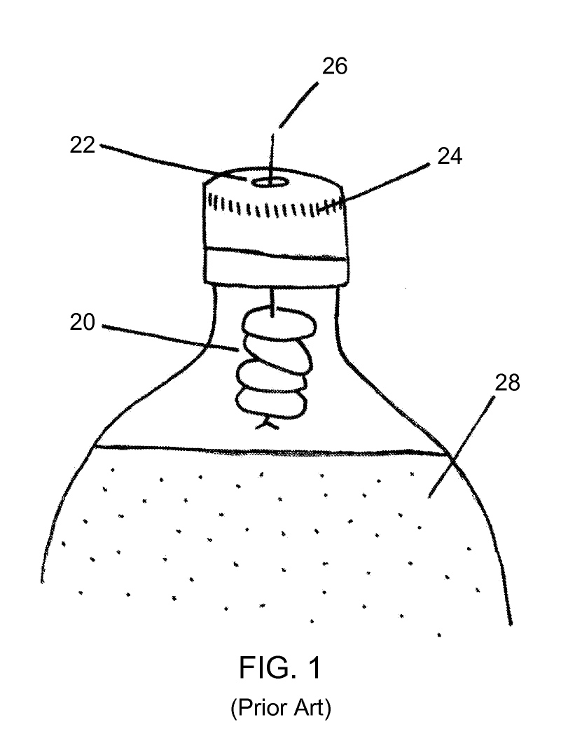

FIG. 2 is a diagram of a soda bottle nozzle.

FIGS. 3A-3C show an illustration of a fountain effect.

FIGS. 4A-4C show an illustration of a fountain effect.

FIGS. 5A-5C show an illustration of a fountain effect.

FIGS. 6A-6C show an illustration of a fountain effect.

FIGS. 7A-7C show an illustration of a fountain effect.

FIGS. 8A-8D show an illustration of a fountain effect.

FIGS. 9A-9C show an illustration of a fountain effect.

FIG. 10 shows an illustration of a fountain effect.

FIG. 11 shows an illustration of remote pin release.

FIGS. 12A-12C show an illustration of a chain reaction method.

FIG. 13 shows an illustration of a chain reaction method.

### DETAILED DESCRIPTION OF THE INVENTION, INCLUDING THE PREFERRED EMBODIMENT

The following detailed description of the invention references the accompanying drawings which form a part hereof, and in which are shown, by way of illustration, specific embodiments in which the invention may be practiced. Other embodiments may be used, and structural changes may be made without departing from the scope of the present invention.

The present invention includes a short tube having an interior diameter that is sized approximately the same diameter as the inside diameter of a generally available soda bottle (currently approximately ¾ inch).

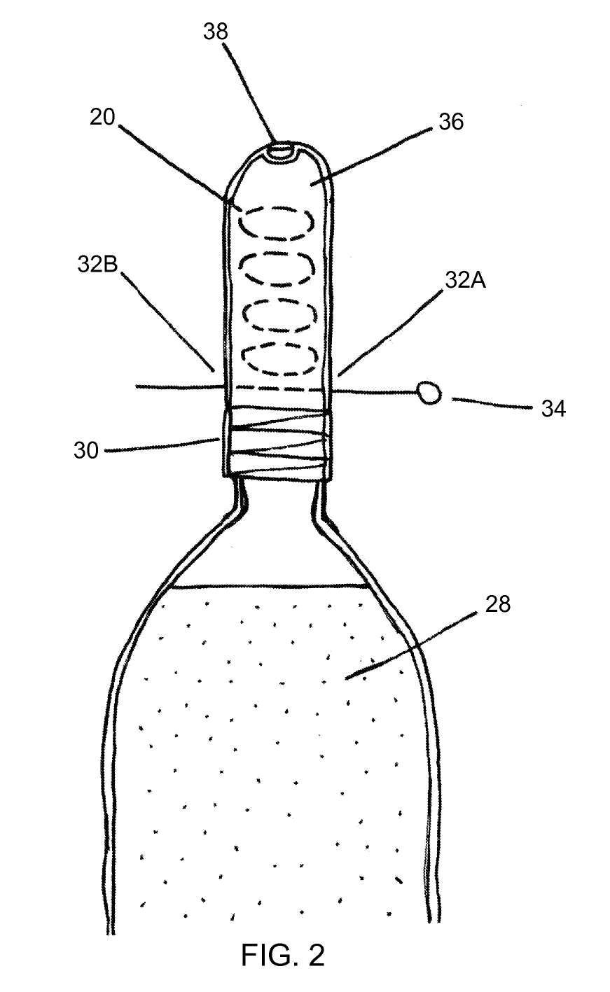

FIG. 2 shows a diagram of the soda bottle nozzle of the present invention. The inside of the lower end of the nozzle tube has threaded connection 30 with threads designed to enable the nozzle to be screwed onto the top of a soda bottle in a substantially water tight connection. Just above the threads there are a small holes 32A and 32B on each side of the nozzle through which removable pin 34 is inserted. In chamber 36, the area above a positioned pin is preferably large enough to hold several candies 20 or other small items for starting soda eruptions. The top of the nozzle has an opening 38 (or openings) through which erupting soda escapes.

The device is used by removing pin 34 from small holes 32A and 32B. One or more candies 20, or small items, are loaded into chamber 36. Pin 34 is replaced so that candies 20 are held in chamber 36 by pin 34 when the nozzle is positioned upright. Such a loaded nozzle is screwed onto existing threads of a recently opened bottle of carbonated soda. The bottle with loaded nozzle is preferably placed in a safe location and then pin 34 is removed.

Upon removing pin 34, candies 20 fall into soda 28 below causing the carbonation in the soda to be released rapidly and causing the geyser to erupt. As soda erupts out of the bottle it shoots up into the nozzle and out opening 38 in the top of the nozzle. The nozzle controls fluid flow to create a geyser-like fountain, the shape of which is determined by the number and shape of openings in the top of the nozzle.

The invention enables fountain effects. The shape and number of the holes or openings in the top of the nozzle determine the shape and number of streams of soda that will erupt from the device. The present invention includes several fountain effects.

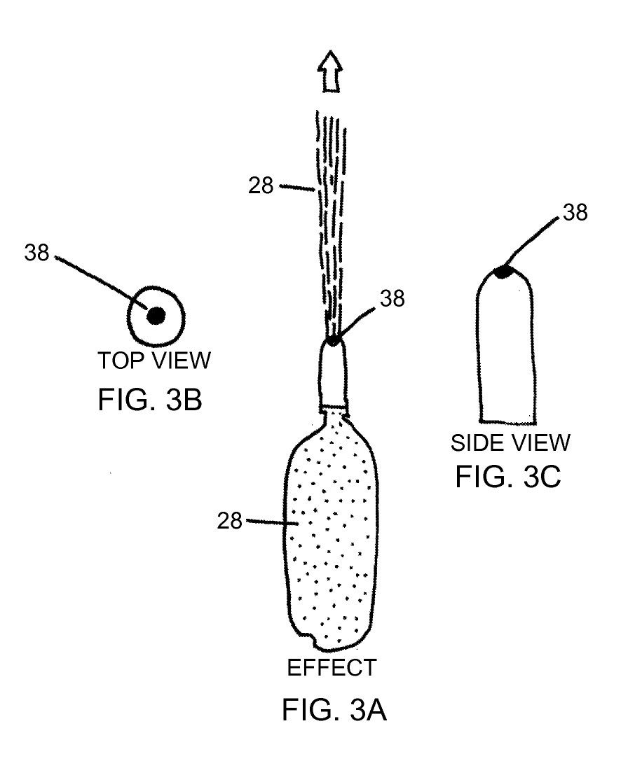

In FIGS. 3A-3C, a single centered circular opening 38 creates single vertical geyser 28. A large hole (e.g., ½ inch), creates a thick stream of soda, while a smaller hole (e.g., ⅛ inch) creates a thinner stream that lasts longer.

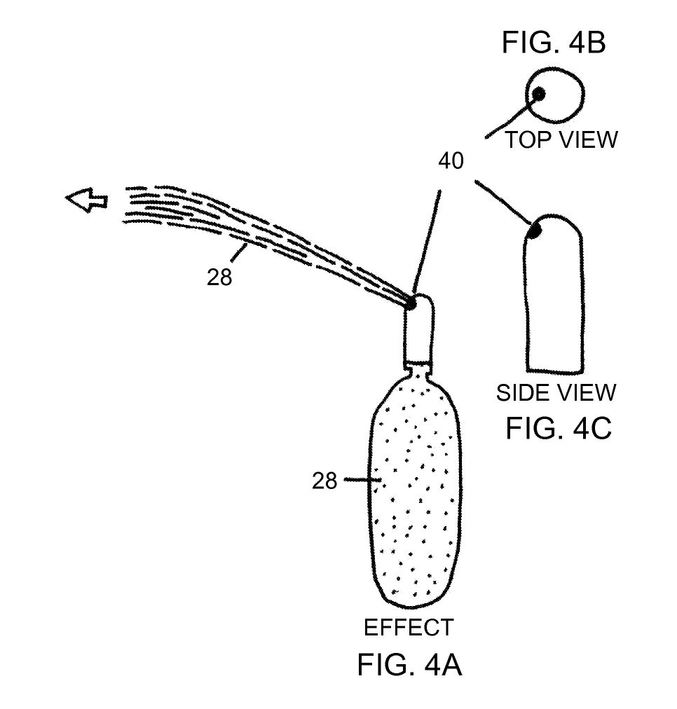

In FIGS. 4A-4C, a single off-center circular opening 40 creates a single angled geyser.

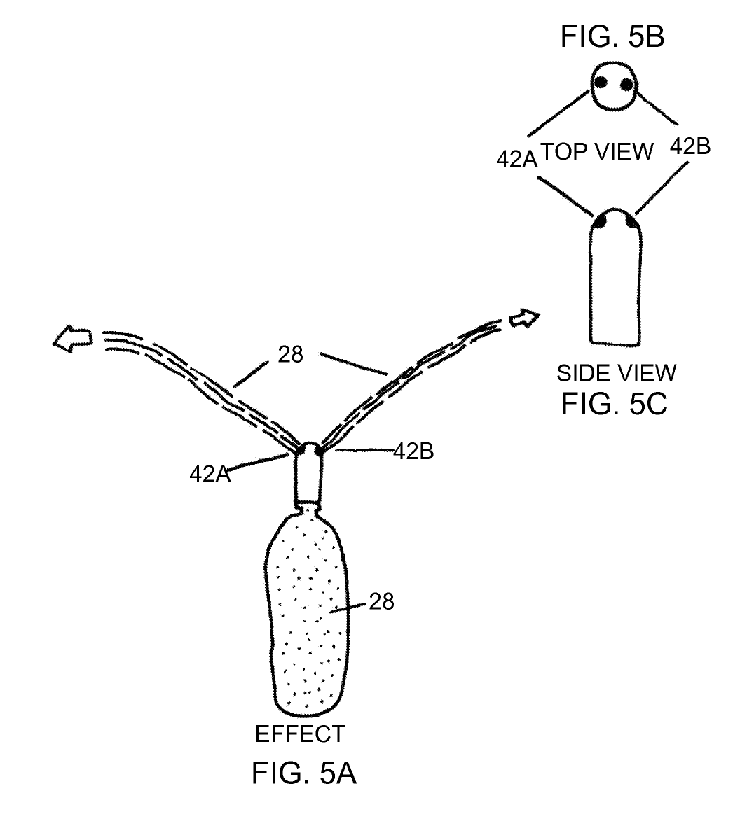

In FIGS. 5A-5C, two holes 42A and 42B, one on each side of the nozzle, create two angled streams that erupt in opposition to each other.

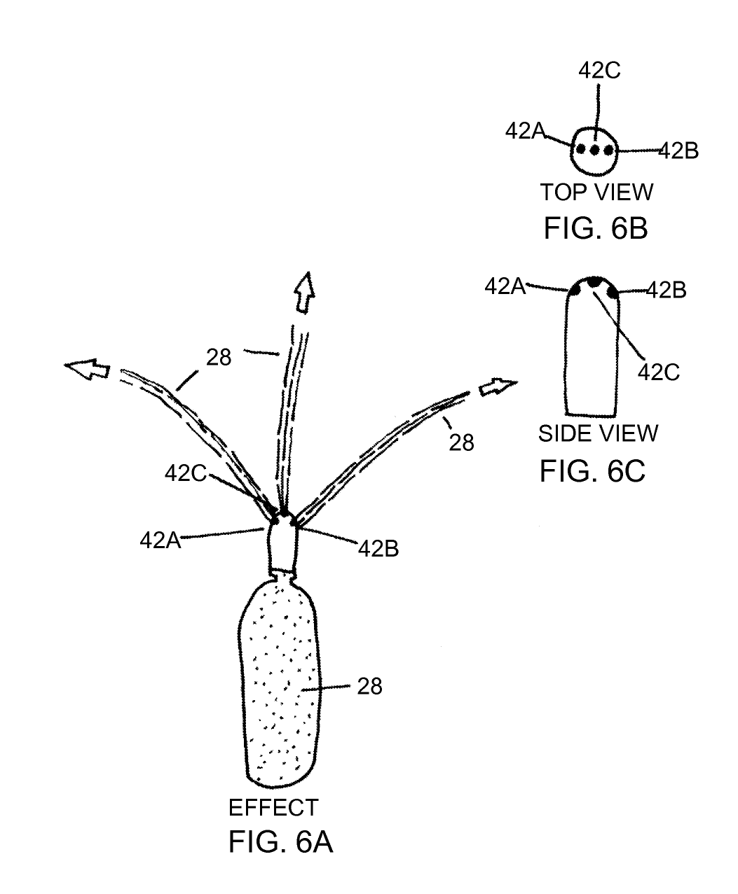

In FIGS. 6A-6C, three or more holes 42A, 42B, 42C in a line across the top of the nozzle create a fan-like set of streams in a single plane.

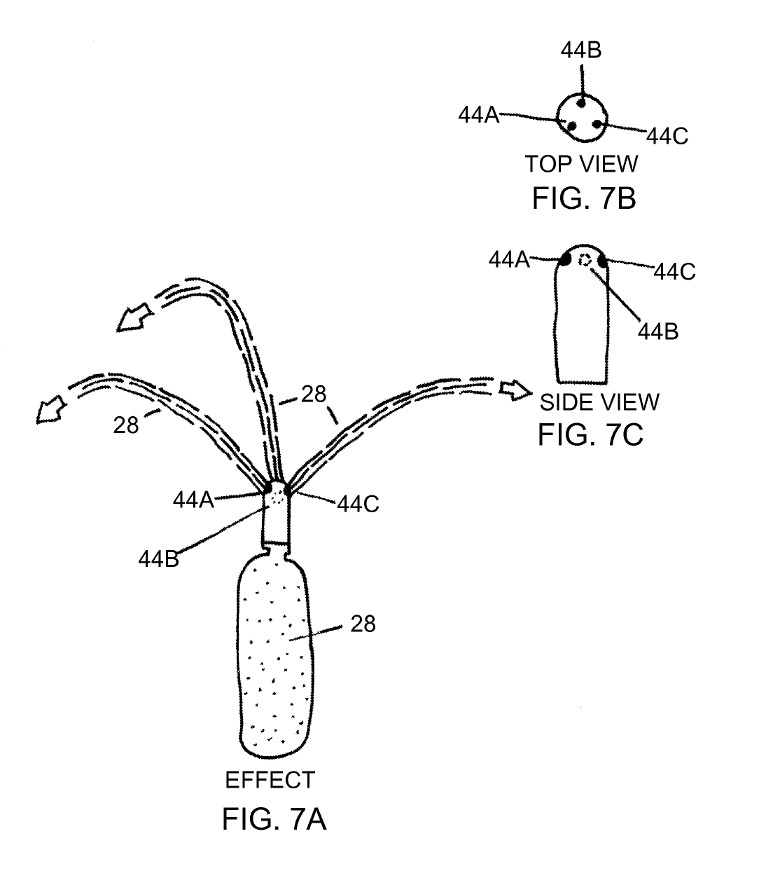

In FIGS. 7A-7C, three or more holes 42A, 42B, 42C in a circle or partial circle around the top create a circle of streams.

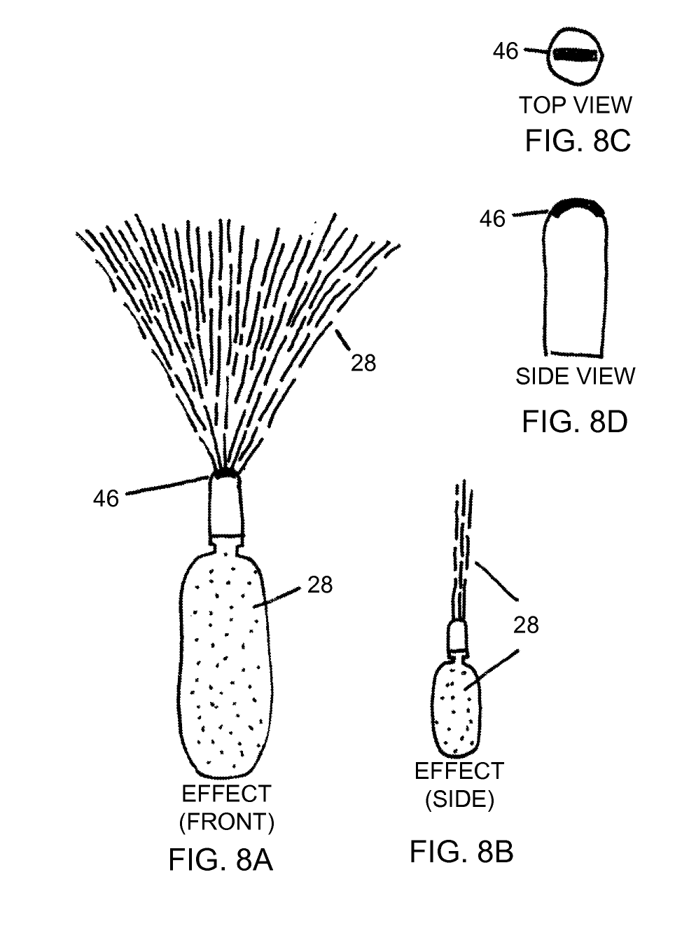

In FIGS. 8A-6D, single or multiple slits 46 across the top of the nozzle creates a single fan-shaped stream for each slit.

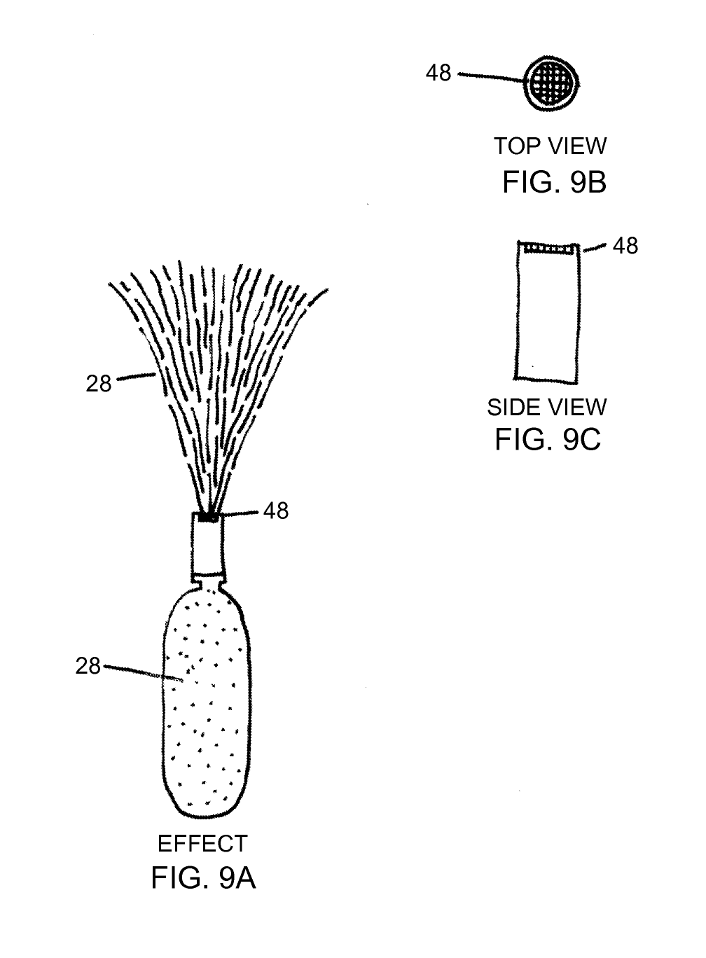

In FIGS. 9A-9C, in place of a closed top with a hole or holes, the top of the nozzle contains a section of screen. This screen creates a short, full, conical fountain.

The present invention also provides for two-stage effects. Two-stage effects can be created from a single bottle by using off-center holes that release a geyser flow to a single side.

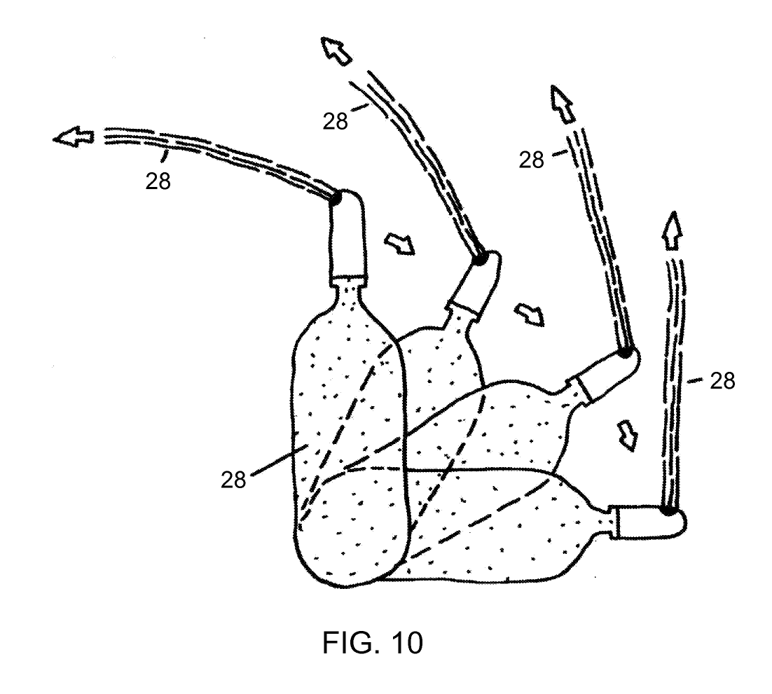

If a bottle is not otherwise supported, the initial effect of such holes will be a stream or set of streams jetting out of the side on which the holes are placed. As a geyser erupts and the soda empties out of the bottle, however, the weight of the bottle and soda will decrease and the force of the still erupting side pointing geyser will tip the now partially empty—and therefore lighter—bottle over and the jet will be abruptly redirected upwards creating an effect in which the geyser initially erupts out at an angle, but about halfway through the effect, suddenly changes its angle, pointing straight up for the duration of the effect as illustrated in FIG. 10.

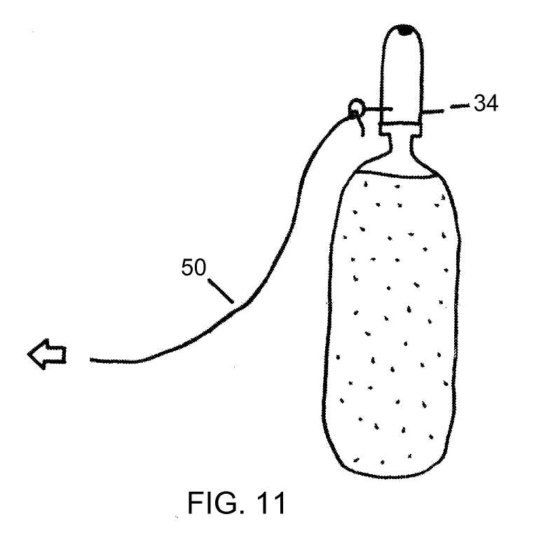

Referring to FIG. 11, the invention includes remote release. Remote pin release designs enable multiple bottles to be loaded and released together by tying string 50 to each pin 34 and pulling the strings simultaneously, or by attaching pins for multiple bottles to a single string.

The invention includes chain reaction releases. In a chain reaction release, a geyser effect from one bottle pulls a pin from a second bottle. A series of such bottles can be chained together so that any number of geysers can be set off one after the other, all by just pulling the pin on the first bottle.

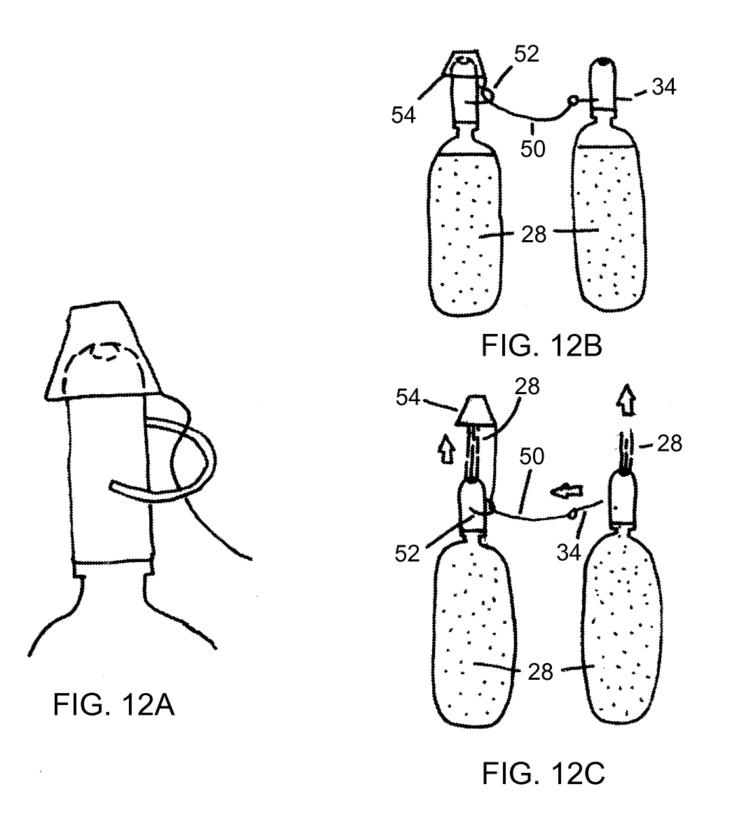

FIG. 12 illustrates one chain reaction method. In this method, the nozzle described above is modified. Ring 52, or other string guide device, is attached to the side of a nozzle which is loaded and attached to a full bottle of carbonated soda. Small cup 54 is placed on the top of the nozzle. One end of string 50 is attached to cup 54. The opposite end of string 50 is attached to pin 34 on a second nozzle. This second nozzle is loaded and attached to a second full bottle of carbonated soda.

The second nozzle can be similarly equipped with its string attached to the pin on a third bottle. Any number of bottles can be arranged in a chain in this manner. When the first bottle is triggered and the geyser erupts, the fountain of soda upwardly propels cup 54 on top of the nozzle, which in turn pulls string 50 to which it is attached. This in turn pulls out pin 34 from a second or additional nozzle in a second or additional bottle which releases candies and sets off a geyser from a second or additional bottle. A second bottle may be similarly attached to a third, or to several more bottles, which in turn may be chained to additional bottles.

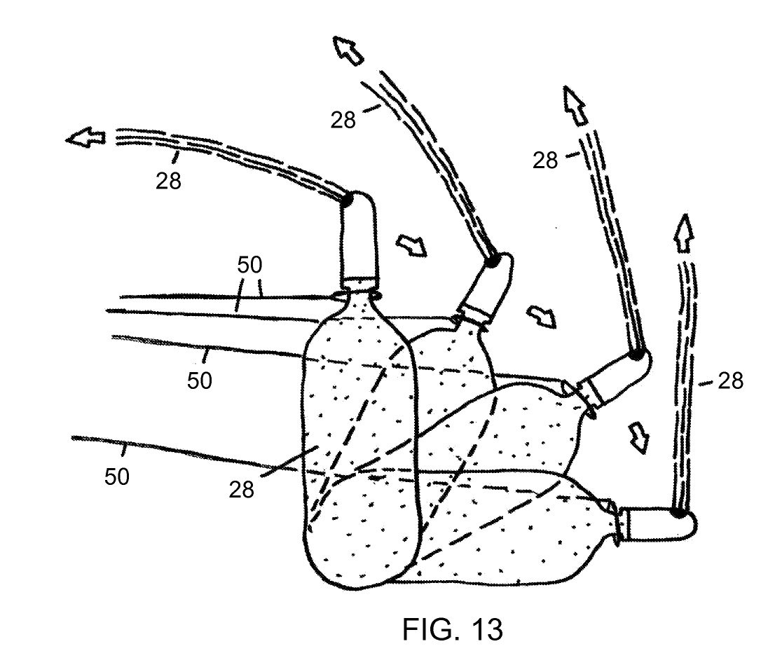

FIG. 13 illustrates a second chain reaction method. For this chain reaction method, the two-stage effect described above is used to pull pin 34 on a second bottle. One end of a string 50 is attached to the top first bottle and the other end is attached to pin 34 on a second bottle, which is placed on the same side as the hole in the nozzle on the first bottle.

The first bottle is triggered. When the resulting geyser has ejected enough soda out of the bottle so that the bottle tips over, the tipping of the bottle pulls string 50 which pulls out pin 34 from the second bottle releasing the candies in the nozzle in the second bottle and triggering a geyser reaction in the second bottle. The second bottle can be similarly chained to an additional bottle or bottles.

The above description is illustrative, and not restrictive. Many other embodiments will be apparent to those of skill in the art upon reviewing the above description. Determine the scope of the invention with reference to the appended claims, along with the full scope of equivalents to which such claims are entitled.

1. A method of creating a soda geyser, the method comprising:
providing a tubular nozzle having a first end and second end, wherein the first end is adaptable to secure to a conventional soda bottle, wherein the second end has a nozzle orifice for controlling fluid flow, and wherein the nozzle has a pin opening located near the first end for receiving a removable pin;
loading candies into the tubular nozzle and inserting a removable pin into the tubular nozzle to hold the candies in the tubular nozzle, thereby creating a loaded nozzle;
securing the loaded nozzle to an opened bottle of soda; and
removing the removable pin thereby causing candies to fall into a bottle of soda and create an eruption of soda.

2. The method of claim 1, wherein the nozzle orifice is off-center to create a two-stage effect.

3. The method of claim 1, further comprising attaching a string to the removable pin for remote release.

4. The method of claim 1, further comprising linking a removable pin on a second loaded nozzle to a first loaded nozzle such that a geyser from a first soda bottle and nozzle is designed to trigger a geyser from a second soda bottle and nozzle.

5. The method of claim 1, further comprising linking a first soda bottle, having a nozzle orifice that is off-center, with a second nozzle and second soda bottle such that the first soda bottle tipping over, from an eruption, triggers a geyser in the second nozzle and soda bottle.
